(19) United States
(12) Patent Application Publication
(10) Pub. No.: US 2025/0118907 A1
(43) Pub. Date: Apr. 10, 2025

(54) CONTACT ELEMENT AND CONTACT INSERT

(71) Applicant: Phoenix Contact GmbH & Co.KG, Blomberg (DE)

(72) Inventors: Detlef NEHM, Schieder-Schwalenberg (DE); Manuel TÜNKER, Dörentrup (DE); Lukas BRILLO, Höxter (DE); Joshua SCHLEBUSCH, Steinheim (DE)

(21) Appl. No.: 18/907,720

(22) Filed: Oct. 7, 2024

(30) Foreign Application Priority Data
Oct. 9, 2023 (DE) 102023127401.5

(51) Int. Cl. H01R 4/18; H01R 13/506; H01R 13/627

(52) U.S. Cl. CPC H01R 4/184; H01R 13/506; H01R 13/6271

(57) ABSTRACT

A contact element for a connector includes: a contact portion; a linking portion; and a conductor-connecting portion. The linking portion is disposed between the contact portion and the conductor-connecting portion. The contact element is made of a flat piece of metal by punching or cutting and deformation processing. An annular retaining element is mounted on the contact element in the linking portion, the retaining element serving to fix the contact element in place in a receiving chamber of a contact insert.

### CROSS-REFERENCE TO PRIOR APPLICATION

Priority is claimed to German Patent Application No. DE 102023127401.5, filed on Sep. 10, 2023, the entire disclosure of which is incorporated by reference herein.

### FIELD

The invention relates to a contact element for a connector, having a contact portion, a linking portion, and a conductor-connecting portion, the linking portion being disposed between the contact portion and the conductor-connecting portion. The contact element is made from a flat piece of metal by punching or cutting and subsequent deformation processing. The invention also relates to a contact insert for a connector, having a main body and a plurality of contact elements.

### BACKGROUND

Various embodiments of contact elements are known in the art. They are used to create an electrical connection to a correspondingly configured mating contact element. The mating contact element is matched in shape to the geometry of the contact element or of the contact portion thereof. The contact element may be in the form of a contact socket, in which case the mating contact element has the shape of a contact pin, which is inserted into the contact portion of the contact socket to establish contact. The contact portion may have, in particular resilient, contact arms which are elastically deformed when inserting the mating contact element, so that this elastic deformation creates a restoring force as a contact force, resulting in a corresponding contact pressure on the mating contact element, i.e., the contact pin. Alternatively, the contact element may be in the form of a contact pin, in which case the mating contact element has the shape of a contact socket into which the contact pin can be inserted. Regardless of the specific design, the contact element and the mating contact element together form a socket/pin combination, with one of the two elements performing the function of the socket and the other element performing the function of the pin.

The contact elements each have a conductor-connecting portion via which the end of a conductor can be connected to the contact element. The conductor-connecting portions may be configured differently, for example, as crimp connections, screw connections, spring-cage connections, push-in connections, or as insulation displacement connections.

Contact elements for connectors are mostly made by turning from solid wire or bar stock, so that the contact elements are solid at least in the linking portion. Machining contact elements from wire or bar stock makes the manufacture of such contact elements relatively complex, so that this type of manufacture is less economical, especially in the case of large production quantities.

In addition to contact elements made from wire or bar stock, there are also contact elements which are made from a flat piece of metal by punching or cutting and deformation processing. Especially in the case of large production quantities, making contact elements by punching and deformation processing is considerably more economical than making them by machining. This is also true for contact elements which must have a particularly high conductivity since this requires the use of copper materials, which are difficult to machine.

Generally, a plurality of contact elements are arranged in a corresponding contact insert. The contact insert has a main body, which may also be referred to as a contact carrier and in which are formed a plurality of continuous receiving chambers extending therethrough, each adapted to receive a contact element. Various designs and shapes of such contact inserts, which generally include a housing receiving and enclosing the main body, are used in industrial wiring systems to produce releasable electrically conductive connections between individual leads. The contact inserts are often used in connectors and corresponding mating connectors. For this purpose, the contact inserts are positioned and secured in the housing part of a connector.

The contact inserts may be in the form of contact inserts with a fixed number of positions, where the number and type of the contact elements arranged in the main body cannot be changed. Such contact inserts with a fixed number of positions enable a high contact density, i.e., a large number of contact elements per unit area. However, in order to meet the requirements of as many applications as possible, many different variants with different connector faces and different numbers and types of contact elements are needed.

In addition, contact inserts may be in the form of modules which each have a small number of contact elements and are inserted and secured in a separate holding frame. Once fully equipped with the respective contact inserts, the holding frame can be inserted into a housing part of the connector and secured therein. Because the contact inserts can be individually inserted into the holding frame, it is possible to equip a holding frame with different modular contact inserts, depending on the application.

During the manufacture of the contact inserts, first the contact elements must be inserted into and secured in the individual receiving chambers in the main body, regardless of whether the contact inserts are of the type having a fixed number of positions or whether the contact inserts are intended to be inserted as modules into a holding frame. In order to provide a secure hold for the contact elements in the receiving chambers, the contact elements may be adhesively bonded into the receiving chambers or overmolded during the manufacture of the main body. However, both of these methods involve increased complexity. Alternatively, the individual contact elements may be pressed into the receiving chambers, which, however, results in limitations on the materials that can be used for the main body.

In practice, it is also known to insert individual contact elements into the receiving chambers and latch them in place therein. To this end, the individual receiving chambers have latching hooks formed therein, and the individual contact elements made by turning from solid wire or bar stock are formed with a continuous circumferential collar, the collars and the latching looks being latched together when the contact elements are fully inserted in the receiving chambers. With such contact inserts, the contact elements can be easily inserted into main body of the contact insert and fixed in place therein, even mechanically. However, in the case of contact elements which are made from a flat piece of metal by punching or cutting and deformation processing, the circumferential collar required for interlocking is difficult to produce.

### SUMMARY

In an embodiment, the present invention provides a contact element for a connector, comprising: a contact portion; a linking portion; and a conductor-connecting portion, wherein the linking portion is disposed between the contact portion and the conductor-connecting portion, wherein the contact element is made from a flat piece of metal by punching or cutting and deformation processing, and wherein an annular retaining element is mounted on the contact element in the linking portion, the retaining element being configured to fix the contact element in place in a receiving chamber of a contact insert.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a perspective view of a first exemplary embodiment of a contact element;

FIG. 2 shows the contact element and the retaining element of FIG. 1 in a state prior to being latched together;

FIG. 3 shows a perspective view of a second exemplary embodiment of a contact element;

FIG. 4 shows the contact element and the retaining element of FIG. 3 in a state prior to being latched together;

FIG. 5 shows a perspective view of a contact insert;

FIG. 6 shows a sectional view of a portion of the contact insert, with a contact element according to FIG. 3 inserted therein;

FIG. 7 shows a perspective view of a portion of the main body of a contact insert, with a contact element inserted therein;

FIG. 8 shows a portion of the main body of FIG. 7; and

FIG. 9 shows a sectional detail view of a portion of the contact insert, with a contact element according to FIG. 1 inserted therein.

### DETAILED DESCRIPTION

In an embodiment, the present invention provides a contact element of the above-described type which is both simple and economical to manufacture and capable of being easily inserted into a contact insert and securely fixed in place therein.

In an embodiment, the invention provides a contact element wherein an annular retaining element which is mounted on the contact element in the linking portion of the contact element, the retaining element serving to fix the contact element in place in a receiving chamber of a contact insert.

The use of a separate annular retaining element that is mounted on the contact element eliminates the need to additionally form a circumferential collar on the contact element during shaping of the punched-out piece of metal into the cylindrical contact element. Thus, the contact element according to the invention is comprised of a punched-out and bent part forming the contact portion, the linking portion, and the conductor-connecting portion, and of the additional annular retaining element. Both the punched-out and bent part and the annular retaining element are very simple to manufacture. Preferably, the retaining element is at least partially made of plastic, which facilitates push-fitting of the retaining element onto the contact element.

In order to fix the retaining element in place in the linking portion of the contact element, the retaining element is preferably interlockingly and/or frictionally mounted on the contact element. This, too, simplifies the manufacture of the contact element since it eliminates the need for additional fastening steps, which would be required, for example, to adhesively bond the retaining element to the contact element.

In accordance with a preferred embodiment, the retaining element and the contact element are configured such that the retaining element latches in place on the contact element. For this purpose, a plurality of snap-fit elements are formed on the retaining element, and corresponding complementary snap-fit elements are formed in the linking portion of the contact element. The retaining element may, for example, be formed at its inner periphery with resilient latching arms having respective latching noses, which engage in corresponding openings in the linking portion of the contact element when the retaining element is in its intended position on the contact element. To this end, the retaining element may be slipped onto the contact element, in particular from the end of the contact portion to the linking portion.

The retaining element may be configured as a circumferentially continuous ring, especially if it is made of plastic. Alternatively, the retaining element may have a slit extending in the longitudinal direction of the contact element, which allows the retaining element to slightly expand as it is slipped onto the contact element. This makes it easier to slip the retaining element over the contact portion of the contact element, which is advantageous, particularly when the outer diameter of the contact portion increases in the direction of the connection portion, such as is sometimes the case with contact sockets. If the retaining element has a slit extending in the longitudinal direction of the contact element, the snap-fit elements formed on the retaining element may be configured as relatively rigid latching noses which are formed directly on the annular retaining element and not connected to the retaining element via resilient latching arms.

Depending on whether the contact element is configured as a contact pin or as a contact socket, the contact portion is pin-shaped or socket-shaped. If the contact element is configured as a contact socket, the contact portion preferably includes a plurality of resilient contact arms, between which a corresponding contact pin of a mating connector can be inserted. The resilient contact arms may be bent slightly inwardly in the direction of their free ends. The free ends, in turn, are bent slightly outwardly, i.e., away from each other, so that they form an insertion funnel for a corresponding contact pin to be inserted between the resilient contact arms.

The conductor-connecting portion of the contact element can be configured in different ways, depending on the application, and may, for example, form part of a screw connection or of a push-in connection. Preferably, however, the conductor-connecting portion is configured as a crimp connection or as a welding leg to which an electrical conductor can be connected. With a conductor-connecting portion configured in this way, the contact element can have particularly small dimensions.

In accordance with another advantageous embodiment, the retaining element serves not only to fix the contact element in place in a receiving chamber of a contact insert, but also to key or code the contact element. This can reduce the risk of a contact element inadvertently being inserted into an incorrect receiving chamber of a contact insert. This makes it possible, for example, to reduce the risk of a contact element connected to a phase conductor being inserted into a receiving chamber that is intended for a grounding connection. The coding or keying of the contact element may be implemented, for example, by different colors or contours of individual retaining elements.

In addition to the aforedescribed contact element, the invention also relates to a contact insert for a connector, having a main body and a plurality of contact elements according to the invention. The main body of the contact insert has formed therein a plurality of continuous receiving chambers extending therethrough, each adapted to receive a contact element. The individual receiving chambers each have formed therein a plurality of latching arms and a bearing edge located opposite and spaced from the free ends of the latching arms. The latching arms and the bearing edge are disposed relative to each other such that the retaining element of a contact element is disposed and fixed in place between the bearing edge and the free ends of the latching arms when the contact element is fully inserted in the receiving chamber. The retaining element is then disposed such that its end face facing the contact portion rests against the bearing edge, while the free ends of the latching arms rest against the opposite end face of the retaining element, which faces the conductor-connecting portion. In this way, the retaining element, and thus also the contact element, is securely fixed in position in the main body of the contact insert, even when a pulling force acts on the contact element via a connected conductor in a direction opposite to the direction of insertion of the contact element into the contact insert or the receiving chamber.

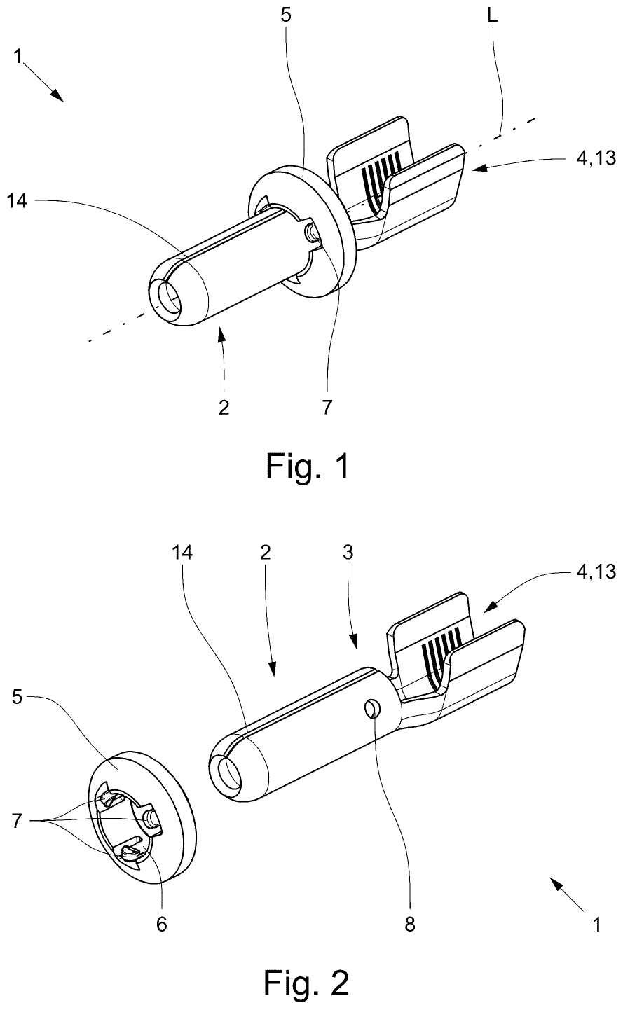

FIG. 1 shows a first preferred exemplary embodiment of a contact element 1 for a connector, the contact element 1 including a contact portion 2, a linking portion 3, and a conductor-connecting portion 4. In linking portion 3, which is disposed between contact portion 2 and conductor-connecting portion 4, an annular retaining element 5 made of plastic is mounted on contact element 1. FIG. 2 shows contact element 1 and retaining element 5 in a state prior to being latched together. The contact element 1 shown in FIGS. 1 and 2 is configured as a pin contact, so that its contact portion 2 is pin-shaped.

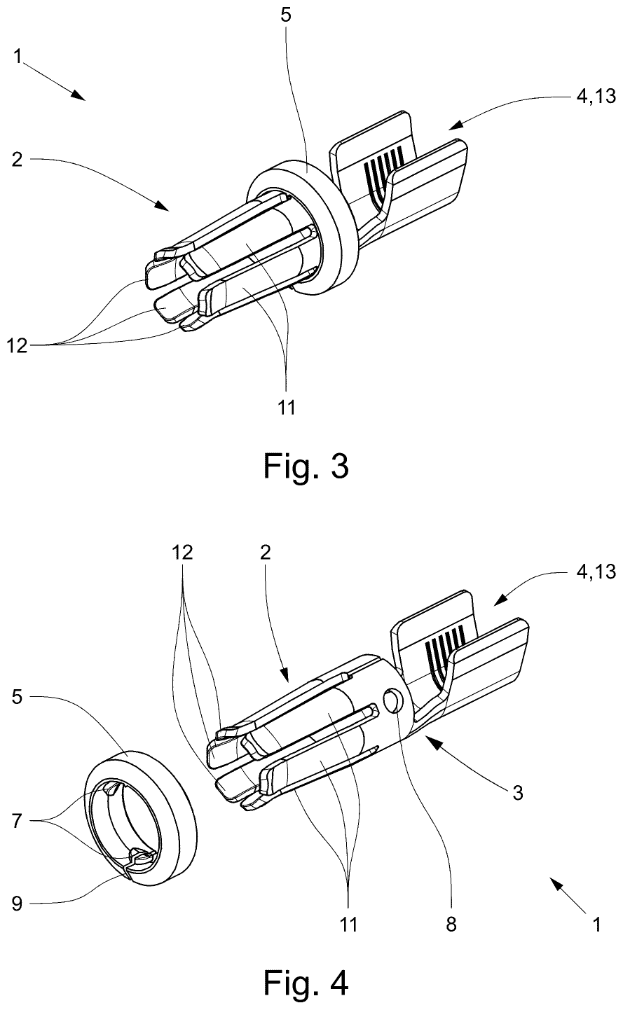

FIGS. 3 and 4 show a second exemplary embodiment of a contact element 1, FIG. 3 showing contact element 1 with retaining element 5 push-fitted thereon, and FIG. 4 showing contact element 1 and retaining element 5 in a state prior to being connected together. Unlike the contact element 1 of FIG. 1, the contact element 1 shown in FIGS. 3 and 4 is not configured as a pin contact, but as a socket contact. Thus, the pin-shaped contact portion 2 of the contact element shown in FIG. 1 could be inserted into the socket-shaped contact portion 2 of the contact element 1 of FIG. 3.

In order to mount the retaining element 5 separately shown in FIG. 2 on contact element 1, retaining element 5 is formed at its inner periphery with three resilient latching arms 6 as snap-fit elements, the free ends of latching arms 6 each having a latching nose 7 formed thereon. Three openings 8 are punched into linking portion 3 of contact element 1 as complementary snap-fit elements corresponding to latching noses 7 of retaining element 5. Latching noses 7 engage in these openings when retaining element 5 is fully slipped onto the contact element 1 (see FIG. 1).

In the case of the contact element 1 shown in FIGS. 3 and 4, which is configured as a socket contact, retaining element 5 can also be latched into place in linking portion 3 of contact element 1. For this purpose, retaining element 5 has latching noses 7 as snap-fit elements, and corresponding openings 8 are formed as complementary snap-fit elements in linking portion 3.

Apart from the slightly different configuration of snap-fit elements 6, 7, the retaining elements 5 shown in FIGS. 2 and 4 differ in that the retaining element of FIG. 2 is circumferentially continuous, while the retaining element of FIG. 4 has a slit 9 extending in the longitudinal direction of contact element 1. The slit 9 formed in retaining element 5 enables retaining element 5 to expand more easily as it is slipped onto contact element 1 from the end of contact portion 2.

Since the contact element 1 shown in FIGS. 3 and 4 is configured as a socket contact, its contact portion 2 includes a plurality of resilient contact arms 11. Resilient contact arms 11 are bent slightly inwardly in the direction of their free ends 12. Free ends 12, in turn, are bent slightly outwardly, so that free ends 12 together form an insertion funnel for a corresponding mating contact element, i.e., a contact pin to be inserted between contact arms 11.

In each of the exemplary embodiments of contact element 1 illustrated in FIGS. 1 through 4, conductor-connecting portion 4 is configured as a crimp connection 13, to which the stripped end of an electrical conductor to be connected can be electrically and mechanically connected. Contact elements 1 are each made from a flat piece of metal by punching and deformation processing, so that contact element 1 is hollow and has a gap 14 extending parallel to longitudinal axis L at the junction. Contact elements 1 have a basically cylindrical shape, especially in contact portion 2 and in linking portion 3.

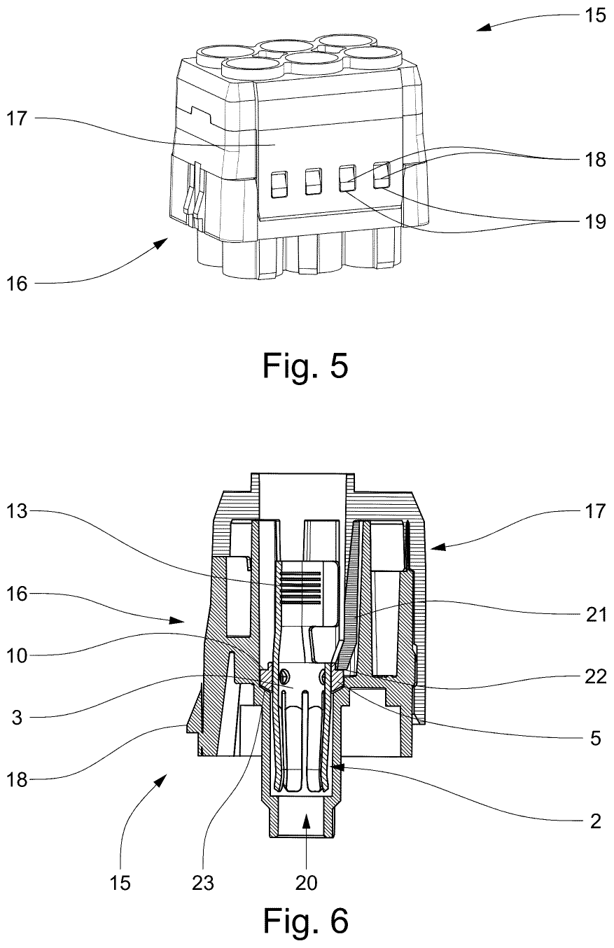

FIG. 5 shows a perspective view of an exemplary embodiment of a contact insert 15 for a connector, contact insert 15 having a main body 16 and a housing 17 at least partially receiving main body 16. Main body 16 and housing 17 are coupled by means of a plurality of latching noses 18 which are formed laterally on main body 16 and engage in corresponding latching openings 19 in housing 17.

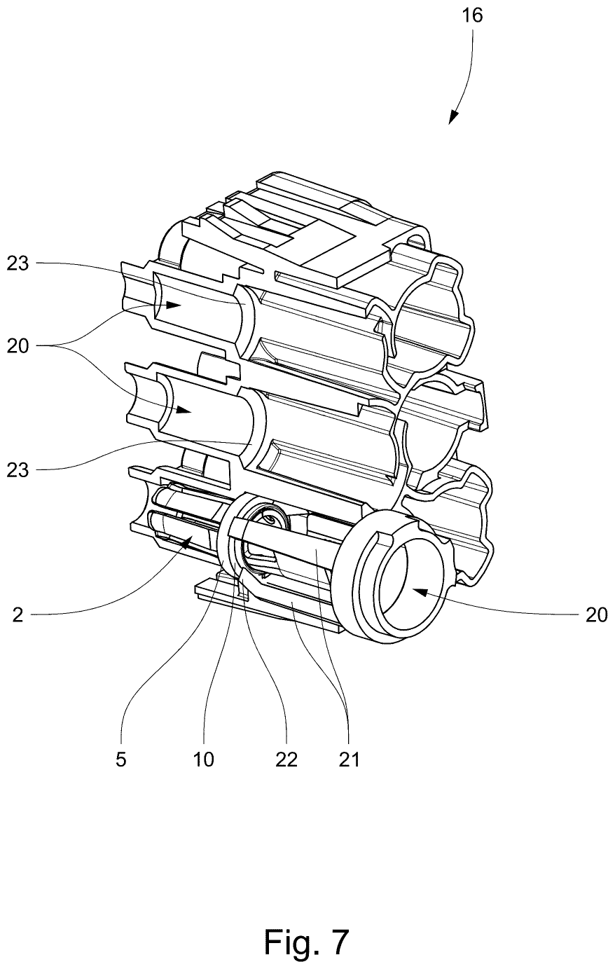

FIG. 6 shows a sectional view of a portion of contact insert 15, with a contact element 1 configured as a socket contact inserted therein. Main body 16 has formed therein a plurality of continuous receiving chambers 20 extending therethrough, each capable of receiving a contact element 1. As can be seen particularly from the perspective view of FIG. 7, which depicts a portion of main body 16, receiving chambers 20 each have disposed therein a plurality of latching arms 21, the free ends 22 of latching arms 21 being bent slightly inwardly. Moreover, the individual receiving chambers 20 each have formed therein a bearing edge 23 located opposite and slightly spaced from free ends 22 of latching arms 21. When a contact element 1 is in the inserted position in receiving chamber 20, retaining element 5 is located between circumferential bearing edge 23 and free ends 22 of latching arms 21, whereby contact element 1 is fixed in place in receiving chamber 20 in the longitudinal direction of contact element 1. In this position, the end face of retaining element 5 facing contact portion 2 rests against bearing edge 23. At the end face of retaining element 5 facing connecting portion 4, there is formed a circumferential shoulder 10 against which the freed ends 22 of latching arms 21 rest.

Thus, when a pulling force acts on contact element 1 via a connected conductor, contact element 1 is retained by latching arms 21 in its intended position in receiving chamber 20. This is because the engagement of shoulder 10 of retaining element 5 against free ends 22 of latching arms 21 prevents contact element 1 from being retracted in a direction opposite to insertion direction E.

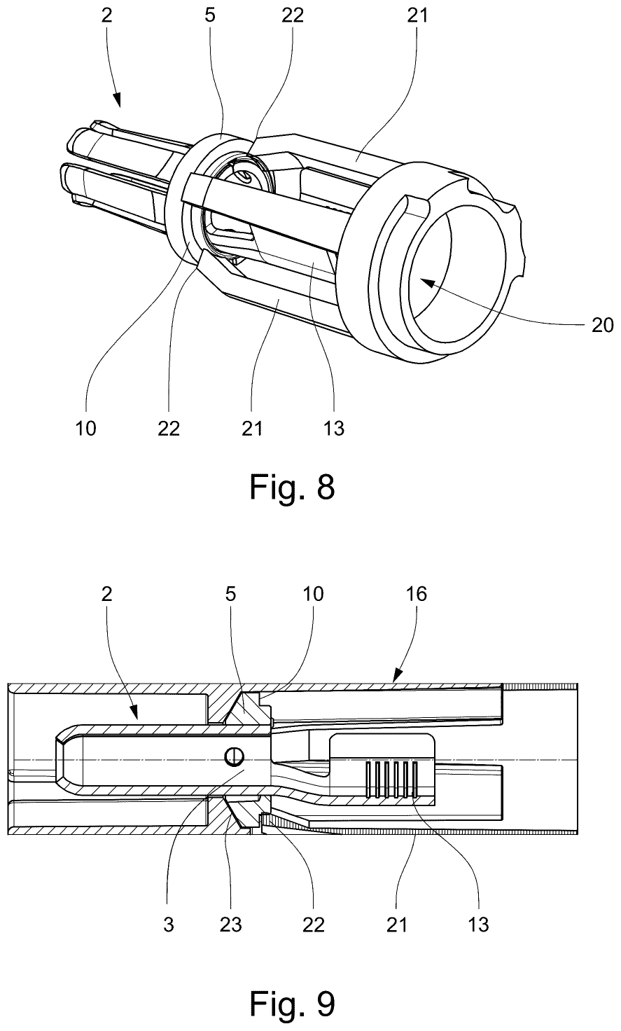

The engagement of free ends 22 of latching arms 21 against shoulder 10 of retaining element 5 can also be seen in the perspective view of FIG. 8 and in the sectional view of FIG. 9. Thus, by disposition of the respective retaining element 5 on contact element 1, the latter is securely retained in the receiving chamber 20 of a contact insert 15, regardless of whether contact element 1 is configured as a contact pin or as a contact socket. Contact element 1 can be formed as a punched-out and bent part, so that the manufacture of contact element 1 is more economical than that of a corresponding contact element made by turning from wire or bar stock.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1. contact element
2. contact portion
3. linking portion
4. conductor-connecting portion
5. retaining element
6. snap-fit element (latching arm)
7. snap-fit element (rib)
8. complementary snap-fit element (opening)
9. slit
10 shoulder
11. contact arms
12. free ends
13. crimp connection
14. gap
15. contact insert
16. main body (contact carrier)
17. housing
18. latching noses
19. latching openings
20. receiving chamber
21. latching arms
22. free ends of the latching arm
23. bearing edge

1. A contact element for a connector, comprising:
a contact portion;
a linking portion; and
a conductor-connecting portion,
wherein the linking portion is disposed between the contact portion and the conductor-connecting portion,
wherein the contact element is made from a flat piece of metal by punching or cutting and deformation processing, and
wherein
an annular retaining element is mounted on the contact element in the linking portion, the retaining element being configured to fix the contact element in place in a receiving chamber of a contact insert.

2. The contact element of claim 1,
wherein the retaining element is interlockingly and/or frictionally mounted on the contact element.

3. The contact element of claim 2,
wherein the retaining element is latched in place on the contact element, for which purpose the retaining element comprises snap-fit elements, and the contact element comprises corresponding complementary snap-fit elements.

4. The contact element of claim 1,
wherein the retaining element comprises plastic.

5. The contact element of claim 1,
wherein the retaining element is circumferentially continuous.

6. The contact element of claim 1,
wherein the retaining element has a slit extending in a longitudinal direction of the contact element.

7. The contact element of claim 1,
wherein a shoulder is formed on the retaining element at an end face facing the conductor-connecting portion.

8. The contact element of claim 1,
wherein the contact portion is pin-shaped.

9. The contact element of claim 1,
wherein the contact portion includes comprises a plurality of resilient contact arms.

10. The contact element of claim 1,
wherein the conductor-connecting portion comprises a crimp connection or a welding leg.

11. The contact element of claim 1,
wherein the retaining element is configured to key or code the contact element.

12. A contact insert for a connector, comprising:
a main body; and
a plurality of the contact element of claim 1,
wherein the main body has formed therein a plurality of continuous receiving chambers extending therethrough, each continuous receiving chamber of the plurality of continuous receiving chambers being configured to receive a respective contact element of the plurality of contact elements,
wherein each continuous receiving chamber has formed therein a plurality of latching arms and a bearing edge located opposite and spaced from free ends of the latching arms, and
wherein the retaining element of the respective contact element is disposed and fixed in place between the bearing edge and the free ends of the latching arms when the contact element is fully inserted in the receiving chamber in the main body.

13. The contact insert of claim 12,
wherein the main body is disposed in a housing.
